(19) United States
(12) Patent Application Publication
(10) Pub. No.: US 2009/0228937 A1
(43) Pub. Date: Sep. 10, 2009

(54) System for Matching Fans with Presentations and Monetizing Presenting Venues

(76) Inventor: Ronald J. Williams, Brooklyn, NY (US)

Correspondence Address: CENTRAL COAST PATENT AGENCY, INC, 3 HANGAR WAY SUITE D, WATSONVILLE, CA, 95076, US

(21) Appl. No.: 12/044,462

(22) Filed: Mar. 7, 2008

(51) Int. Cl. H04N 7/173

(52) U.S. Cl. 725/86

(57) ABSTRACT

A service for pairing individuals with venues includes an internet-connected server, software executing from a data repository associated with the server, an interactive interface provided by the software, enabling individuals to input information and access services, and information stored in the data repository regarding at least identity of venues, being enterprises that retail to the public and also provide presentations of possible interest to the individuals. In one embodiment an individual accessing the service may input either a current or a future location and at least one interest in presentation content, and the service will render to the individual identity of venues proximate to locations entered by the individuals, and providing presentations coinciding with the interest input by the individual.

### BACKGROUND OF THE INVENTION

1. Field of the Invention

The invention is in the field of network search, and pertains more specifically with matching viewers with appropriate demographically or psychographically targeted audiences in presentation environments.

2. Description of Related Art

Each day, in the USA and in most countries foreign to the USA, a great variety of programming is presented in public venues, one example of which is sports bars and restaurants. Many such venues in the USA are local establishments with a single TV screen that typically tune to programs presented by the National Basketball Association, the National Football League, the National Hockey League and the like. Others are larger, more focused establishments that may be franchised, like sports bars, and these may have several screens tuned to different sports programming. Still others may display programming other than sports, such as concerts or other cultural events, movies or educational content. There are also a great variety of live presentations, such as rock concerts, self-help seminars, and much, much more. The present invention has application in all such venues. In the case of Sports Bars and Restaurants, sports may be the prevalent type of programming viewed in public, and sports presentations will be used in following description as examples of programming by venues to which the present invention is applicable, but the invention is not limited in any way to sports presentations.

In varied regions in the USA and countries foreign to the USA there is interest in the NBA, NFL and NHL, as well as regionally specific local sports (e.g. Canadian Football League, cricket, Aussie rules rugby). Some sports enjoy a global audience (such as soccer), while others are limited in their appeal. What is almost limitless is the breadth of sports presentations with substantive fan bases. Sports such as Cricket, Tennis, Rugby, Motocross, Curling and many more all boast fan bases in the thousands to millions in some cases.

It is well known that in all of the known organized sports there is significant competition among radio and broadcast services for rights to broadcast and televise competitions. Such broadcasts span a variety from elementary school basketball games to the super bowl. It would be difficult to even estimate the hours of sports programming broadcast in a day or a week on the planet Earth, or the size of the audience, although many try to estimate the audience as a key in advertising placement and pricing.

Content networks such as Fox, Home Box Office (HBO), ABC, NBC, CBS, BBC et al. provide widely dispersed and quite reliable guides to their future programming. TV Guide and others provide broad dissemination of future programming selections that will be made available by the networks and by independent sources. Many events, such as sporting and cultural events, and especially “big-ticket” events such as the annual NBA championships and the Super Bowl are widely advertised. Collectively, all of the information just described is information about the downstream flow of content from providers (such as producers of event-related content) to network aggregators (such as Fox, NBC, etc.) and finally through the various distribution channels that get content to the point where it is viewed, for instance, broadcast networks, cable television (CATV) networks, Internet Protocol television (IPTV) networks, satellite television (SATV) networks and even physical media distribution networks such as NetFlix. But information about choices made at the receiving end of this “content value chain” where the programming is actually displayed, such as in people's homes sports bars, restaurants and the like is much more difficult to capture. Individuals may invite groups of friends over to watch major events together, and restaurants and bars may advertise or establish reputations locally to inform potential patrons about their facilities and their programming and presentation plans, but all such information is very limited and fragmented. The enterprises, who present sports and other content in hopes of building public awareness of their venues and thus growing their customer and revenue bases, typically use these content offerings to attract customers.

There is another common aspect of sports events and fans that is important to the present invention, specifically, that being a fan is almost universally a social phenomenon. Fans of particular teams participate and enjoy performances of their team far more in the active presence of other fans, than alone. As a result, many fans prefer to watch performances in social settings. In many respects, the factors that collectively define the “atmosphere” of a social setting where sports or other media content is viewed is as important as the content selection itself in establishing the overall viewing experience. Accordingly, fans will typically desire to choose venues based on content and atmosphere. This phenomenon is particularly marked in the case of sports event viewing, but it can pertain to other sorts of content as well without limiting the scope of the instant invention. For instance, many popular film and television awards presentations are widely viewed, and many people who view them would prefer to do so in social settings, and particularly in social settings with appropriate “atmosphere”.

It is also well-known that people travel every year more and more, increasingly spending time away from local neighborhoods and familiar surroundings, both on business and recreationally. A person who is a fan of a sport or of a particular team, in his or her local environment, is familiar with just about everywhere that he or she may view games or performances, at home or at a local bar, sports bar or restaurant. But that same person, on the road, may not be able to find a suitable place to enjoy camaraderie with fellow fans while rooting for a favourite team. Similarly, even when in familiar surroundings, the event, performance or programming that an individual desires to view may not be popular locally. In this situation, it is unlikely in the current art that such programming would be available in a social setting in the individual's local area, because there is little incentive for venue operators to deviate from the programming choices of the majority of their patrons. Since there is no system for matching viewing preferences and venues in the art, venue operators do not have access to the detailed information that is needed to allow rich segmentation to occur, such as is provided by the instant invention.

What is clearly needed is a new system that affords individuals the ability to locate available media presentations and to receive information about the nature of audiences (social atmosphere) at those presentations, and at the same time affords operators of presenting venues, such as sports bars, a new ability to attract patrons and more effectively monetize their activity in presenting media programming in their establishments.

### BRIEF SUMMARY OF THE INVENTION

The present inventor has recognized a need for a system and apparatus which will provide advance information for persons who desire to interact with others in viewing presentations of various sorts, such as, for example, sports presentations. In one embodiment of the invention a service for pairing individuals with venues is provided, comprising an internet-connected server, software executing from a data repository associated with the server, an interactive interface provided by the software, enabling individuals to input information and access services, and information stored in the data repository regarding at least identity of venues, being enterprises that retail to the public and also provide presentations of possible interest to the individuals. In one embodiment an individual accessing the service may input either a current or a future location and at least one interest in presentation content, and the service will render to the individual identity of venues proximate to locations entered by the individuals, and providing presentations coinciding with the interest input by the individual.

In another aspect of the invention a service for pairing individuals with venues is provided, comprising an internet-connected server, software executing from a data repository associated with the server, a first interactive interface provided by the software, enabling individuals to input information and access services, and a second interactive interface provided by the software, enabling venues, being enterprises that retail to the public and also provide presentations of possible interest to the individuals, to input information, including identity and scheduled presentations, and to access services. In one embodiment an individual accessing the service may input either a current or a future location and at least one interest in presentation content, and the service will render to the individual identity of venues proximate to locations entered by the individuals, and providing presentations coinciding with the interest input by the individual.

### BRIEF DESCRIPTION OF THE SEVERAL VIEWS OF THE DRAWINGS

FIG. 1 is a diagram illustrating a system in an embodiment of the present invention.

FIG. 2 is a simple illustration of an interactive display in an embodiment of the invention.

FIG. 3 is an alternative interactive display in an embodiment of the present invention.

FIG. 4 is a diagram illustrating architecture of hardware and software in a venue in an embodiment of the present invention.

### DETAILED DESCRIPTION OF THE INVENTION

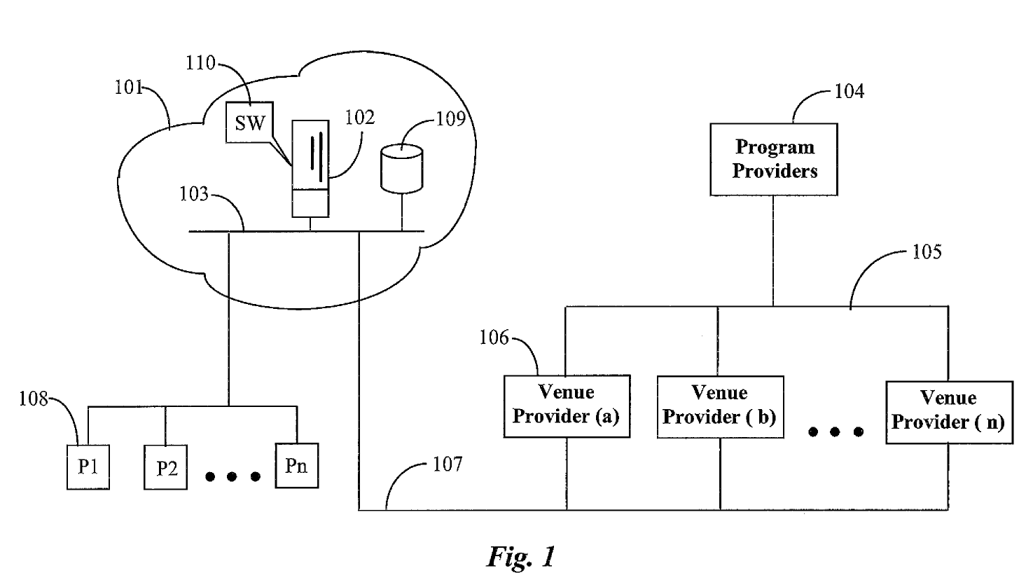

FIG. 1 is a diagram illustrating a system in an embodiment of the present invention. The system broadly comprises venues 106, which may be bars, sports bars, restaurants and the like that regularly and typically provide programming for entertainment of their customers. Program providers 104 may be conventional broadcast-oriented networks such as Fox, Home Box Office (HBO), ABC, NBC, CBS, BBC et al., specialized program providers such as local public access channels or Internet-based content providers using Internet protocol television (IPTV) capabilities, or any head-end provider capable of providing displayable programming to individual ones of the venues. A simple example is sanctioned broadcast of the Super Bowl game provided by the National Football League, and broadcast by one of the major TV networks in the USA, which may also be provided to local stations in the USA and to broadcasters in other countries by arrangement. Another example is a major heavyweight championship boxing match, which may be broadcast, for example, by Home Box Office (HBO) over cable or satellite feed, and may be paid for by individual venue operators through a variety of means well-known in the art.

Program providers 104 are coupled to venues 106 by any one or more of a variety of coupling systems 105, which may include satellite broadcast, cable service, conventional TV local broadcast, IPTV over the well-known Internet network, or in any other ways that images or audio may be streamed. The invention is not limited by the manner in which programming may be provided by program providers 104 to venues 106.

Venues 106 are shown connected to Internet network 101 by couplings 107, which may be any sort of coupling, such as a modem through an Internet Service Provider (ISP), a DSL service over a telephone line, a wireless link supported by a cellular telephone service, connection through the systems of the media content provider to the “head end” or “central office” of the provider, and from there to the Internet via a coupling hosted in the media content provider's systems, or any other known link for Internet access. Couplings 107 are meant to illustrate Internet connection by which venues 106 may interact with an Internet service 102 hosted by an enterprise and enabled by an Internet-connected server, central to the invention, that provides a service to Internet-connected individuals 108, venues 106 and in some embodiments also to program providers 104.

Individuals 108 are, in one embodiment, travelers, as described above in the background section, who may be, for example, fans of a particular sports team, as described above, and who may be away from their usual environment. Individuals 108 are understood to be enabled with Internet-connected devices, such as Personal Digital Assistants, Internet-connectable cellular telephones, laptop computers, and the like, with which they may browse the Internet, and by which that may access pages provided by service 102, which provides information and other services through execution of software 110. Furthermore, individuals 108 may access these devices and peruse available viewing opportunities from any location, such as their hotel room, an airport lounge, or even a venue 106 operated by one of the venue operators (presumably, but not necessarily, when the content or the atmosphere at that venue does not meet the needs of the user), without limiting the scope of the present invention. In another embodiment, individuals 108 are not travelers, but people who are looking for particular media content in their own area, either because of a desire for a particular atmosphere in which to view common content, or because of a desire to see content that is not mainstream enough to be readily available at many venues. For instance, expatriate workers may desire to see sports or cultural programming from their home country in social settings in their adopted cities, as for example when an Indian expatriate desires to see a key cricket match in a friendly setting with other cricket enthusiasts. It should be understood that individuals 108 could be anyone who wants to know what content is available, where and when, and in what environmental setting or atmosphere; the examples described herein accordingly should not be taken to limit the scope of the invention.

In typical embodiments of the invention service 102 is provided by an internet-connected server, as mentioned above, has access to a data repository 109, and executes software 110 to provide services. This architecture is intentionally shown rather simply, but is meant to represent all of the variety of known architecture and hardware and software combinations that might be used for the purpose.

In one embodiment of the present invention venues 106 may not be clients of service 102, or even Internet connected by coupling 107. In this rather simple embodiment service 102 gathers information about a broad variety of venues 106, from sources such as advertisements made by the venue operators, Internet searches conducted by service 102, and by a variety of other means, regarding programming to be presented by venues 106, and at least some further information about the ambience to be expected at an individual venue. The ambience information may be limited to that which may be discerned by the locale of the establishment (venue), the number of screens the establishment may be known to regularly present, and so on. Furthermore, individuals 108 may provide current program viewing options provided by venues 106 in a number of ways, such as by updating service 102 directly over the Internet, posting updates on their preferred social networks, and so forth. In the latter case, as an example, the service 102 could search social network postings for “live” updates or could enter into arrangements with social networks whereby the social networks actively participate in all facets of service 102 and encourage their members to do the same.

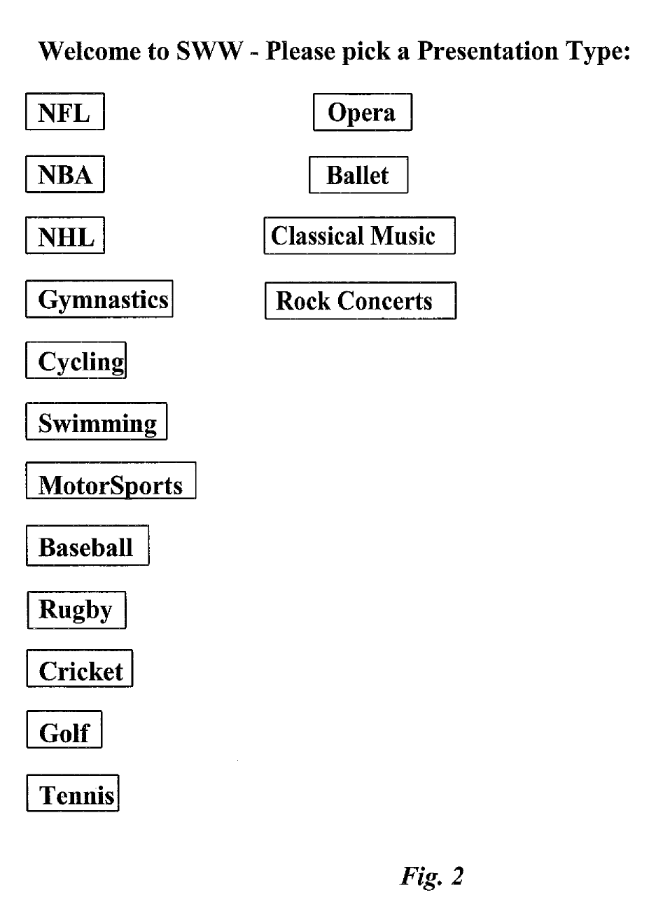

In this rather simple embodiment a first “Home” web page as simply illustrated in FIG. 2 may be provided by service 102 to be accessible by individuals 108. In some embodiments the page may be accessible and operable by the general public, and in some embodiments individuals 108 may be required to register as clients, to be assigned a user name and a password; and in some cases also may be paying clients of service 102.

In the home page illustrated in FIG. 2 each of the types of presentations is shown in a box, simply indicating that each selection is an interactive link to a subordinate page. It will be apparent to the skilled artisan that the list of types of presentations of FIG. 2 is exemplary only, and there may in fact be many, many more types provided for selection. It is known, for example, that there are organized sports leagues in most sports in many countries, and many of these may be presented. In many embodiments there will a choice for language, so a browsing person may obtain the information in his or her first language.

In one embodiment, selecting an interactive link for a type of presentation, such as NBA, will take the individual to a subordinate page that may list, for example, all of the NBA teams, also in interactive fashion, so that a further selection may then display all of the contests that team may have scheduled in the near future, and a selection of a contest may present a window to the user to input a locale. The browsing individual may be, for example, a Boston Celtics fan who knows that he will be in San Francisco on the dates that two Celtics games will be played. Further subordinate pages are not shown here, as such interactive presentation is quite well-known in the art, and it is the nature of the service and not the technology of interactive display that is the patentable subject matter of the present application.

It should be appreciated that the examples provided herein concerning sports programming and sports content (such as teams, leagues, “fans” and the like) are illustrative only and should not be taken to limit the scope of the invention. The invention can be practiced by entities offering, and viewers seeking, programming of any nature. For example, chamber music concerts could be made available simultaneously in many cities at a selection of venues, and chamber music aficionados could then search for and frequent venues where such programming is available. Or, educational content could be offered in a similar way. This could be quite valuable for for-profit universities, for example, as they could partner with third-party venue operators to provide local instruction in various cities via one of the broadcasting means discussed herein; visitors to a city could search for venues where they can watch programming on historical topics in the same way that others can find sports bars. The key concept is the aggregation of present and future programming choices made by venue operators and the provision of this aggregated programming and venue ambience data to users who are searching for an appropriate venue, and monetizing the resulting information exchanges.

After the locale input the system will return information about venues in and around San Francisco who are known to be providing that presentation on that date on one or more screens, or in some other manner. The information for each venue will also include what is known about the ambience to be expected, other services provided by that enterprise (venue), menu, drinks available, opening and closing times, and so on.

In this embodiment individuals may more easily than conventionally find establishments where they may expect to be able to watch a contest or other presentation by a favorite team or group, for example, and also to gain some knowledge and expectation of the type of camaraderie that might be expected as well.

It should be apparent that the order in which input from individuals 108 may be solicited to arrive at a point that the service may provide the information the individual seeks is quite arbitrary, and may be accomplished in a number of different ways. For example, the access to venue information could be provided in a completely different way within a social network, perhaps as a pull-down menu in a “sports widget” made available by the social network operator, a third party widget provider, or even the service 102.

Further, the illustration in this embodiment of types of presentations is, of course, exemplary. Initial selection may start at many different points. For example, the home page may present first a variety of starting points for the user's choice, such as Location, Teams, Sport, Particular Player, or desired ambiance, among many more possibilities, and allow the user to decide the starting point and the drill-down. A user in this embodiment might, for example, select Sports, and then be presented with the interactive display of FIG. 2 as a result. There are many possibilities.

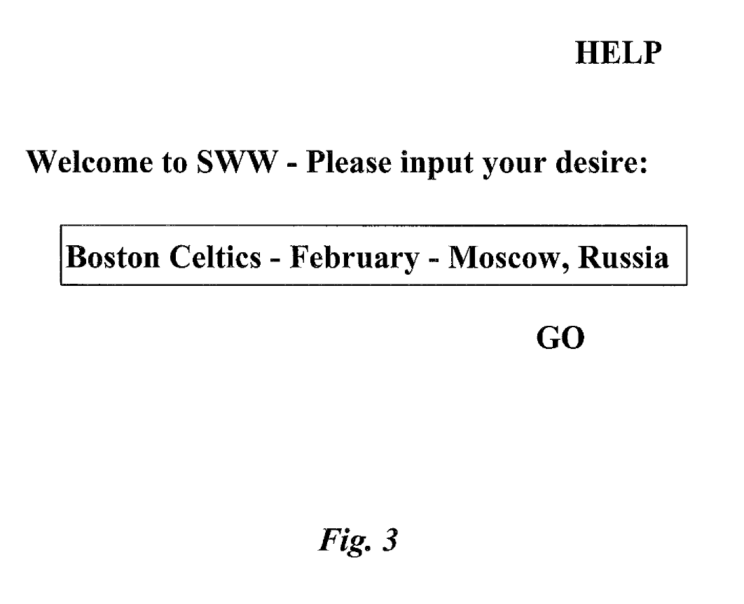

In another embodiment, illustrated in FIG. 3, the “drill-down” technique presented above is not necessary, and the service is organized in a more “search-oriented” fashion, wherein a search-query window is presented, and the individual may input such as “Boston Celtics—February—Moscow, Russia”. In this manner the service 102 may, after the individual criteria input, search its data repository, and directly present, in this example, what venues may be presenting Boston Celtics games in February in Moscow (if any). And the service may provide the additional rich information about each venue as well. The former technique has a small advantage in indicating the scope of information that may be available, while the latter technique is far more direct and eliminates a lot of interactive work by the individual.

In some embodiments the service may be predictive rather than just reactive. That is, an individual client 108 may contact service 102 and input a travel itinerary for a coming period of time, and sports, music, art or other preferences. The service will return what it knows about venues for the dates and locales in the itinerary. In some embodiments the service keeps a profile of the client and already knows the sports team preferences, priorities, and the like, and needs only the itinerary for a useful response.

In a somewhat more robust embodiment, venues 106 may be active participants and clients of service 102. The purpose of providing entertainment options such as sports programming by, for example, a sports bar is to attract customers who may be expected to purchase food and drink, and even hopefully to attract groups of like-minded persons as paying customers. By becoming clients of service 102, venues may make their programming details available and further information about their establishments, which should attract individuals, who might otherwise have more difficulty finding such information. In this embodiment venues 106, via couplings 107 may become members, that is clients, of service 102, and may input to the service a variety of information about their particular establishments, the nature of their own clientele, and above all, their expected programming that would be of interest to individuals.

In some cases venue clients, through a paid arrangement, may provide photographs, testimonials, logos and the like, or even videos and recorded material for advertisement, and may also pay for placement in a list of establishments in a locale that may be providing similar programming. Additionally, “webcams” or cameras whose video feeds are accessible in real time over the Internet, may be placed in the venues and made available by the service 102 so that prospective patrons can see for themselves the ambience, noting for example which team colors are prominently shown or predominant, or what types of patrons are actively engaged in watching the desired presentations, or even if the other patrons are paying attention at all to the presentations. It is a characteristic of the types of venues where entertainment options such as sports are viewed publicly that they vary widely in ambience. In some cases, patrons are there only for the sports programming; this is typical of sports bars, for instance. In others, the sport is something of an afterthought; this is typical of many hotel bars where out-of-town guests may congregate to eat, drink and intermittently to watch sports programming (they are also often likely to watch other programming such as news).

An additional direct benefit to venue operators is to allow for market segmentation that enables a truly differentiated set of viewing options to patrons. For example, venues with fewer screens can stop directly competing with “super sports bars” in geographic proximity in terms of displayed programming. This means that instead of showing, on one or two screens in a smaller venue, a subset of the programming being displayed on the 12 screens at a larger venue a short distance away, a venue may display completely unique programming matched to a set of patron (users of service 102) who can easily find the venue via the search functionality of the invention. The database will, over time, grow to include millions of broadcast media search strings that will be geographically and socially related, enabling delivery to venue operators of pro-active re-segmentation: power to educate a venue operator on what he should be displaying during particular time-slots as informed by data-driven analytics.

Moreover, active venue operators may also retrieve rich information regarding what other venue operators in his locale may be doing, and thus be able to plan more competitive offerings for potential patrons.

In yet another embodiment program providers may actively participate as well, and may establish advantageous relationships with service 102. On-demand services such as IPTV and paid programming like HBO sports events might provide to service 102 their client relationships as they develop. HBO, for example, having scheduled a bantamweight world championship fight, may provide information to service 102 as persons pay to receive their programming, and service 102 may then make the information available to their own individual clients 108.

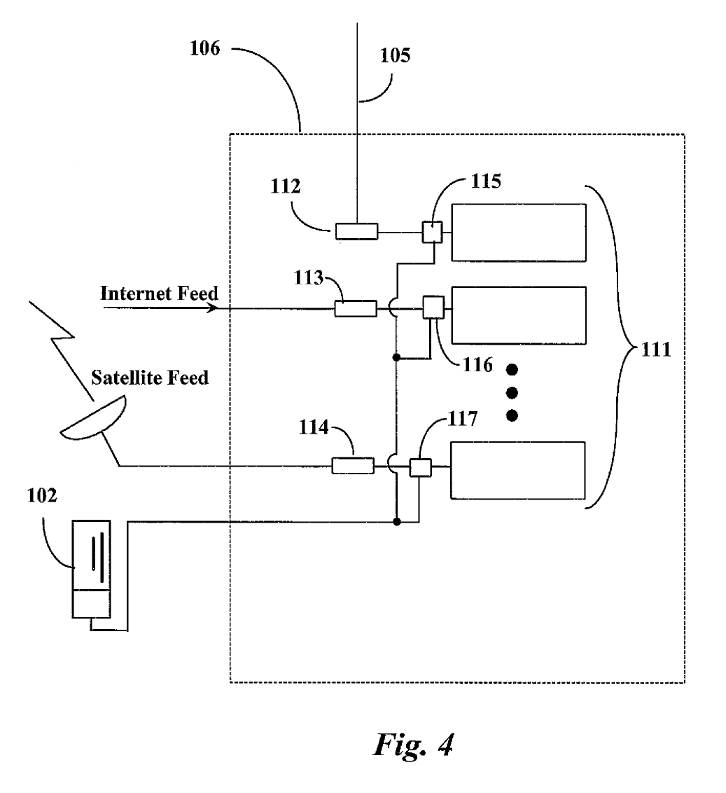

In an even more robust embodiment, venues 106 may be equipped with hardware and software tools to more effectively interact with service 102, to enable service 102 to provide to individuals 108 even further useful information. FIG. 4 is an expanded diagram of architecture at a venue 106. In the particular venue shown there are a plurality of presentation screens 111. One screen 111 is shown driven by a set-top box 112 fed by a television cable feed 105. Some programs provided through box 112 may be broadcast programming, and some may be on-demand, as box 112 may be connected to a telephony link through which demand programming may be requested and paid.

Another screen 111 is shown fed by device 113 from an Internet feed, as will be the case for IPTV. A third screen 111 is driven by a box 114 fed by satellite. A device 115 is illustrated as interposed between box 112 and the associated screen 111, and this device monitors the actual programming being fed to the associated screen in real time. The diagram is illustrative, and device 115 may be a part of box 112, or may be a device added to box 112 in some manner to ascertain the program being screened in real time.

Devices 116 and 117 illustrate equipment similar to device 115, for monitoring the programming being presented on the other screens 111 in real time. Devices 115, 116 and 117 are Internet connected in this example, and provide the program information discerned in real time to service 102 as shown. Service 102 thus, in this embodiment, has real time intelligence as to the programming actually being presented, as opposed to the programming scheduled to be presented.

In this embodiment service 102 compares the real-time programming for each client venue, and rates the performance; that is, do the prediction and schedule equal the reality. This information may be provided to individuals 108 as an aid for the individuals to choose venues to visit. In another embodiment, individuals having made a selection and visited a venue, may access service 102 and rate their experience, which service 102 may use to add to the priority and performance rating for venues. There are a number of ways that real-time monitoring may be done, and the nature of the monitoring, per se, is not a particular issue in the present application. The technology exists, and is available to those with skill in the art.

In another aspect the system of the present invention makes possible several novel and valuable methods of enhancing business results for both venues and an operator of the service 102. First, for the venues, availability of information that was previously unobtainable in virtually any form enables a much more deliberate approach to venue marketing. Heretofore, most marketing of venues such as sports bars and the like has been decidedly local, and generally fairly untargeted. The target demographic has generally been the demographic that is present in the immediate vicinity of the venue at the appropriate times. Thus a downtown sports bar generally markets to the people who are downtown, whereas the venue located near a large suburban mall markets to the demographic that the mall attracts, plus local residents.

Even more restrictive, themed venues such as Irish pubs and the like may have sports entertainment available, but they market their Irish theme to just the local population and perhaps to a small set of local expatriates. Generally, for individuals, it is difficult to tell an Irish-themed pub with a purely local clientele from one that actually draws a significant number of expatriates on a regular basis, since marketing within that community tends to be restricted to word of mouth.

In an embodiment of the invention, venues can directly market to target demographics in a variety of ways. One is the incorporation of a subsystem the inventor terms Team Themes. Team Themes are bundles of programming content determined by a central theme. Individuals 108 may view available media content and venues by first selecting a Team Theme and then selecting from within the thematically-related choices provided by the system 102. Also, theme-based content could be scheduled for viewing at a venue in order to attract particular targeted demographics (i.e., those who are interested exclusively or at least strongly in the particular theme). For instance, there could be a Boston Red Sox Team Theme to which venue operators can commit, consisting of a bundle of games and related programming tied to the Boston baseball franchise. By selecting such Team Themes, venue operators are able to attract particular segments of the potential patron population, including those who might be transient and therefore not likely to be swayed by local traditional marketing efforts. While this may provide scant help in the team's home city, where there are likely to be many venues with similar themes, it can provide a significant marketing boost in other cities. For instance, many Boston fans live in or work in New York City, and such a Team Theme could help venue operators specialize in Boston sports franchises and attract a significant clientele. This is a marked difference from the current practice, where patrons generally choose what is going to be shown; when this is the rule, hometown teams are almost always selected and the challenge for out of town visitors or fans of out of town teams is significant.

In another embodiment of the invention, Team Themes can be more broadly defined than previously, encompassing more than a particular team. For example, a Team Theme could be labelled “Boston” and could aggregate all media content and venue selections that relate to the sports franchises associated with the city of Boston. Or, a Team Theme could be labelled “underdogs” and aggregate all media content and venue selections associated with teams that are widely viewed, within their respective sports, as currently being “underdogs” or teams with poor prospects of winning. In another example, enthusiasts who wager on horse races might prefer a theme labelled “long shots”, which could be defined as any horse with odds worse than 10:1 of winning. Any number of themes could be made available to venue operators in an in-screen menu provided by the hardware or the software components of the invention, to assist in choosing multi-sport display preferences.

Furthermore, the existence of patron feedback mechanisms in the service 102 provides a means for venue operators to differentiate their venue and its associated offers (menus, drink choices, clientele, etc.) from its competitors. For example, having chosen a Team Theme, a venue could compete by ensuring a 100% adherence factor, that is ensuring that the scheduled events for the Team Theme are shown always as promised. Since many potential patrons who choose venues based on input from the service 102 will provide more weight in their selection process to venues who exhibit a proven track record of doing what they say, careful adherence to published schedules will enhance the attractiveness of a given venue. In the same way, feedback concerning clientele mix and ambience can provide a valuable marketing tool (or can hurt a venue operator's business), because when a venue promotes a “lady-friendly” atmosphere, for instance by promising to reserve some media viewing locales within the venue for programming likely to appeal to the partners of those who tend to want to see the “main attraction”, and then by carrying out this promise.

Team Themes may be packages of information that indicate programming related to a particular team. The package will include scheduled contests in which the associated team will participate, but also related programming such as interviews with team members, background information, cheerleader functions, and more. In one case the venue operator may select a Team Theme, for which there may be a price or not, and the venue operator is then responsible for arranging for all of the programming with Program providers. In another case the service 102 may provide the theme, and arrange the programming on behalf of the venue operator, or at least portions of the programming that may not be easily and publicly available.

Furthermore, venue operators will be able to pursue business strategies with the aid of the instant invention that would not have been practical before. For example, in an embodiment of the invention, the operator of service 102 provides analytical reports to venue operators that allow them to identify significant demographics that they can attempt to attract. For example, if there are an average of 1000 business people from Los Angeles in Chicago every weekday night, and they tend to stay in the downtown region or near O'Hare Airport, and an average of 100 of them are users of service 102, then it will be valuable to venues in the vicinity of downtown Chicago or of the airport to obtain additional information about the preferences of this target demographic. This information can be used to structure promotional offers or media viewing selections targeted at these audiences. For instance, a large venue might reserve one room as the Los Angeles Room, show sports programming targeting the LA demographic, and even hors d'oeuvres with a southern California theme. Additionally, in an embodiment of the invention the system 102 provides email updates to users concerning offers that meet their preferences.

This can go a step further, in that service 102 may accept travel itineraries from users and then provide feedback to those users about scheduled events along their trip that will likely interest them based on their stated preferences. Moreover, if service 102 notes that a sudden large increase in traffic from St Louis to Seattle (for instance, for a Boeing corporate event) is taking place in two weeks, it could alert venues in Seattle, some of whom could take the opportunity to set up St Louis-themed events during the period of the increased traffic. Thus it will be appreciated that participation in system 102, which aggregates data about program viewing opportunities at a large number of venues, presents significant new business opportunities for venue operators.

In one embodiment of the invention, the operator of system 102 aggregates data concerning the availability of programs at a large number of venues and makes this data available to prospective patrons of the venues. The availability of this data in aggregate form makes it possible for the service operator to analyze the demographic patterns of the prospective patrons who use the system, and to provide these analyses to venue operators to assist them in driving business. In particular, the service may provide reports to the venue operators indicating the demographic breakdown of users who search for venues in the vicinity of the venue operators. Demographic indices include such things as how many users are local residents, frequent visitors, occasional business travelers, vacationers, and the like. They can also include the sports preferences of users, for instance a venue operator could be informed that a significant number of fans who indicate a desire to watch cricket games exists, perhaps due to the presence of significant numbers of residents and visitors from high technology centers in South Asia. The service operator can charge a premium price for services such as demographic analyses, while possibly making the core aggregation and dissemination of venue programming data available at no charge to venue operators.

In another embodiment of the invention, the service may use the data gathered from individual users of service 102 to preferentially place advertisements on the web pages of service 102 based on the suitability of the advertisements for the target demographic. By specifically targeting subsets of the sports-watching world based on the regional, sports and team preferences of each user, the service may enjoy a high degree of ad click-throughs, thereby generating significant revenue. This revenue might be shared with participating venue operators as a means of inducing the venue operators to actively participate in the system. It will be appreciated that the value of the service 102 will be incrementally increased each time new venue operators and new users access the service; as this occurs, word of mouth will lead to steadily increasing traffic, which allows for more segmentation (because of larger sample sizes of users to be analyzed), and therefore more value for venue operators. As this virtuous cycle operates, it will become increasingly likely that a significant portion of the prospective patrons of sports-oriented venues will choose their programming and themes based on the input from system 102; when this happens the value to the service and to the venue operators, as well as the individual patrons will be maximized.

In another embodiment of the invention, service 102 provides a direct marketing capability to venue operators. Venue operators can specify target populations based on any of a number of criteria, such as Team Themes, region of origin, language, sports preference, exhibited preference for particular types of venues (for example, those with dancing, those with smoker areas, those with multiple large screens, etc.). The venue operators can provide promotional material, whether traditional advertising content, personalized emails, special coupons, and the like, for presentation to users matching their desired demographic who visit service 102's web site. It will be appreciated that there are many kinds of promotional content and techniques that are well-established in the art; what is new in this embodiment of the invention is an ability of venue operators to target particular demographics precisely when those targeted demographics are perusing possible venues for viewing sports or other entertainment programming. This is a form of opt-in enhancement of promotional campaigns, wherein the users opt in by being on the web page or otherwise accessing the distributed functionality of service 102; while they are there, they are actively looking to understand their options to “see what, where (and with whom)”, so they are likely to be receptive to promotional offers from prospective venues.

There are also significant business capabilities inherent in the easy extension of service 102 from a dedicated website approach to a module within a larger entity. In one embodiment, the operator of service 102 is, or may be associated with, an operator of one or more social networks. Social networks are well-known in the art for providing a means whereby large numbers of individuals with specific interests can establish ongoing networks of contacts even where they would have been unlikely to encounter each other before. These social networks, which are allowed to spontaneously form on the larger social networking sites, represent highly self-selected populations who share at least some set of interests or attributes, even if they are very different in other ways. For example, motorcycle enthusiasts will find each other and form strong social networks when they can, and these networks will have in common those interests that are highly correlated with interest in motorcycling. Even so, there will be “old school bikers”, bankers, retired schoolteachers, young and old, male and female people in the network—social networks bring together cohorts with specific interests that otherwise would never be viewed as a demographic to be marketed to. The operator of service 102, when a social network operator, will use data about the profile of the networks to which a particular user is associated to understand in advance what that person is likely to want in a venue. Thus while a person might specify the sport, team and location that they are interested in, the system 102 could also mine data from the social network of the user to determine that the user is an oenophile who prefers high-quality video and audio and a restrained yet focused crowd, rather than a boisterous rugby bar that happens to also be showing the desired team. This linkage of insights from social network data mining with the insights to be gained from aggregating the media programming choices and ambience aspects of a large number of venues optimize the probability of finding the best venue for each user, and for providing superior marketing performance for the venue operators.

It will be apparent to the skilled artisan that there will be a variety of alterations and re-combinations that may be made in the embodiments described above without departing from the spirit and scope of the invention. The service of the invention may incorporate any or all or any combination of the functions and features described in different embodiments. There are likewise many ways that communication may be established between participants in the overall system, and many ways interfaces for input and output may be accomplished, all within the spirit and scope of the invention. The invention is limited only by the claims that follow.

1. A service for pairing individuals with venues, comprising:
an internet-connected server;
software executing from a data repository associated with the server;
an interactive interface provided by the software, enabling individuals to input information and access services; and
information stored in the data repository regarding at least identity of venues, being enterprises that retail to the public and also provide presentations of possible interest to the individuals;
wherein an individual accessing the service may input either a current or a future location and at least one interest in presentation content, and the service will render to the individual identity of venues proximate to locations entered by the individuals, and providing presentations coinciding with the interest input by the individual.

2. The service of claim 1 wherein the presentations are broadcast sports presentations.

3. The service of claim 1 wherein the information regarding venues includes information pertinent to social atmosphere to be expected.

4. The service of claim 1 wherein individuals are subscribers to the service.

5. The service of claim 1 wherein the software provides a mechanism for individuals to feed back personal experience regarding paired venues to the service.

6. The service of claim 5 wherein the service uses the feedback to rate venues, and provides the ratings to other individuals seeking services.

7. A service for pairing individuals with venues, comprising:
an internet-connected server;
software executing from a data repository associated with the server;
a first interactive interface provided by the software, enabling individuals to input information and access services; and
a second interactive interface provided by the software, enabling venues, being enterprises that retail to the public and also provide presentations of possible interest to the individuals, to input information, including identity and scheduled presentations, and to access services;
wherein an individual accessing the service may input either a current or a future location and at least one interest in presentation content, and the service will render to the individual identity of venues proximate to locations entered by the individuals, and providing presentations coinciding with the interest input by the individual.

8. The service of claim 7 wherein the presentations are broadcast sports presentations.

9. The service of claim 7 wherein the information regarding venues includes information about social atmosphere to be expected.

10. The service of claim 7 wherein individuals are subscribers to the service.

11. The service of claim 7 wherein the software provides a mechanism for individuals to feed back personal experience regarding paired venues to the service.

12. The service of claim 11 wherein the service uses the feedback to rate venues, and provides the ratings to other individuals seeking services.

13. The service of claim 7 wherein a service provided to individuals allows an individual to input travel itineraries as well as interests, and the service adds associated venue information to the itineraries.

14. The service of claim 7 wherein a service provided to venues is provision of a Team Theme, being a schedule of programming over a specific time period associated with a particular sport team or organization.
